(19) United States
(12) Patent Application Publication
(10) Pub. No.: US 2015/0215257 A1
(43) Pub. Date: Jul. 30, 2015

(54) CUSTOMIZING COMMUNICATIONS

(71) Applicants: Linda Allan Mosquera, Arlington, MA (US); Reid Michael Mosquera, Arlington, MA (US)

(72) Inventors: Linda Allan Mosquera, Arlington, MA (US); Reid Michael Mosquera, Arlington, MA (US)

(21) Appl. No.: 14/604,667

(22) Filed: Jan. 23, 2015

Related U.S. Application Data
(60) Provisional application No. 61/965,148, filed on Jan. 26, 2014.

(51) Int. Cl. H04L 12/58

(52) U.S. Cl. CPC H04L 51/22

(57) ABSTRACT

Among other things, a curated communication system and method for a party who wants to communicate a customized multimedia message and be provided with expert guidance to simplify the customization.

### CROSS-REFERENCE TO RELATED APPLICATIONS

This application is related to and claims priority based on U.S. Provisional Patent Application Ser. No. 61/965,148 filed on Jan. 26, 2014, the entire contents of which is incorporated herein by reference.

### STATEMENT REGARDING FEDERALLY SPONSORED RESEARCH OR DEVELOPMENT

Not Applicable.

### BACKGROUND

This description relates generally to document creation in computer-based environments, more particularly, to systems and methods for efficient and effective generation of customized communications.

### SUMMARY

In general, in an aspect, a communication system comprising a content layering engine, a communications engine, a notification engine, and an analytics engine wherein a user selects communication messages based on targeted markets. In some embodiments file comparison and merging are performed by operations within a content editing tool such as Microsoft Word. However, differences and similarities between data objects such as computer files or text versions or more complex data structures may be performed by a UNIX diff utility, or by other file comparison programs such as cmp, FileMerge, WinMerge, Beyond Compare or Microsoft File Compare.

In one embodiment, a computer-based method for merging multiple document content variants with a rule-based expert system or wizard through a series of associating variation edits with reasons for that reason into a single customized document. From that single customized document a user can assemble a customized communication wherein the user views a display of variation edits, together with the associated reason for that variation edit, and by selecting variants build the communication layer by layer. For example, the user choosing to generate a sales marketing communication to corporations would select variant layers based on selected criteria such as size of the company, then the audience in the corporate hierarchy, then the type of sales process appropriate to the selected audience and then select differentiation features of the product or service offered depending on existing completion in the market.

In general, in an aspect, a communication system comprising a computer network in connection with a storage location. In some embodiments, communication message components are stored in a database such as Microsoft Access, mySQL or some other ODBC compliant database.

In general, in an aspect, a communication system comprising a content layering engine for layering a plurality of communication messages into a single file. In some embodiments the customized communication messages may be generated as formatted text, as images, as multimedia presentations in for example, Microsoft PowerPoint, or as components of a website with streaming content. In some embodiments an Extensible Markup Language (XML) may be used with a set of Document Type Definitions (DTD) to interpret the customization file to populate controls for tagging files, accessing data samples and generating the graphical user interface (GUI).

In general, in an aspect, a communication system comprising a categories library for each subset of recipients.

In general, in an aspect, a communication system comprising a display module to visualize the user experience of recipients of communication messages.

In general, in an aspect, a communications system comprising a communications engine wherein an assembly module and a display module and a recipient database that are in communication as needed.

In general, in an aspect, a communication system comprising a parsing and interpretation library for comparing communication messages.

In general, in an aspect, a communication system comprising a predictive analytics module for filling in missing data.

In general, in an aspect, a communication system comprising a forecasting models library from which to select a model to forecast response to a communication message.

In general, in an aspect, a communication system comprising a base presentation on which to layer additional modifications.

In general, in an aspect, a communication system comprising layering content securely from a plurality of sources, communicating among a content layering engine, a communications engine, a notification engine, and an analytics engine, notifying the user of communication messaging success, and selecting from alternates using predictive analytics based on historical data.

In general, in an aspect, a communication system comprising connecting with a storage location.

In general, in an aspect, a communication system comprising creating a customizer for the creation of a communication message.

In general, in an aspect, a communication system comprising opening a preset customizer for creating a communications message.

In general, in an aspect, a communication system comprising opening an existing customizer for creating a communications message.

In general, in an aspect, a communication system comprising creating a customizer based on analysis of historical data.

In general, in an aspect, a communication system comprising selecting criteria from a list or adding criteria to a list. For instance, selecting an audience for the communication message, selecting the type of sales process appropriate to the selected audience, selecting the type of competitor in the market, selecting the primary purpose of the communication message, and selecting the size of the target company.

In general, in an aspect, a communication system comprising creating customizers based on predictive analytics and historic data.

In general, in an aspect, a communication system comprising layering content into a single file for easy storage and retrieval.

In general, in an aspect, a communication system comprising storing the customized layers in an on-line storage device. For example, a user could store customized layers in a cloud storage service.

These and other aspects, features, implementations, and advantages, and combinations of them, can be expressed as methods, apparatus, systems, components, program products, business methods, and means or steps for performing functions, or combinations of them.

Other features, aspects, implementations, and advantages will become apparent from the description, the drawings, and the claims.

### DESCRIPTION

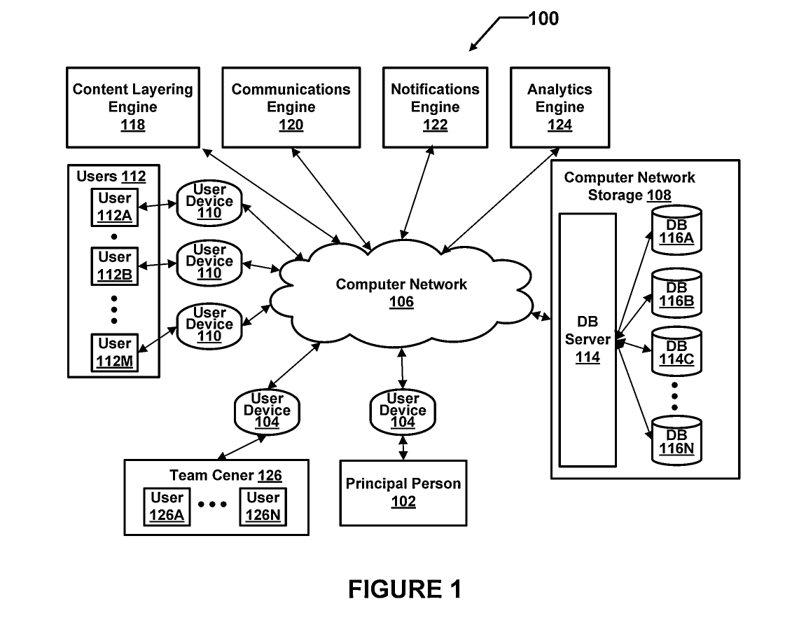

FIG. 1 is a block diagram of a Computer Network or other system.

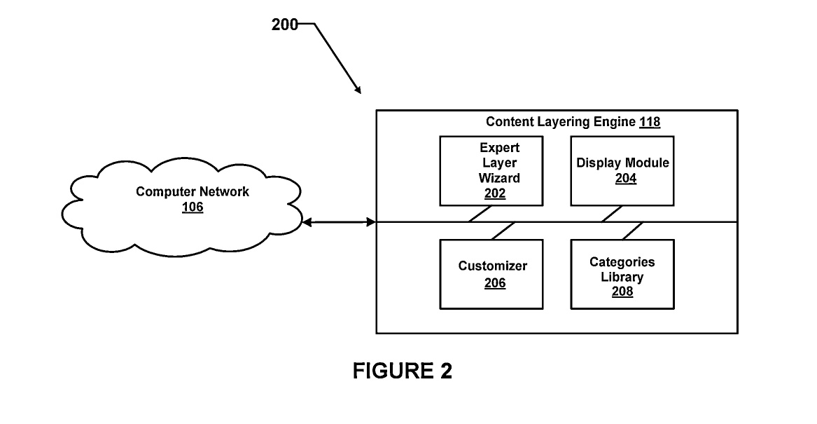

FIG. 2 is a block diagram of a Content Layering Engine.

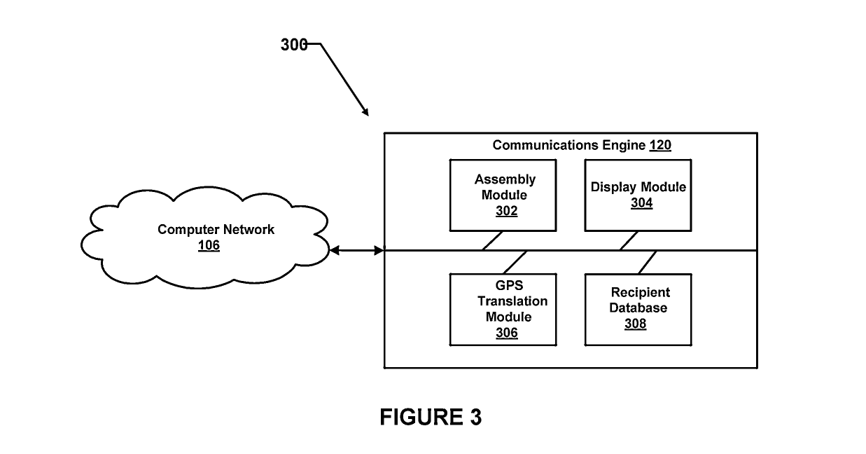

FIG. 3 is a block diagram of a Communication Engine.

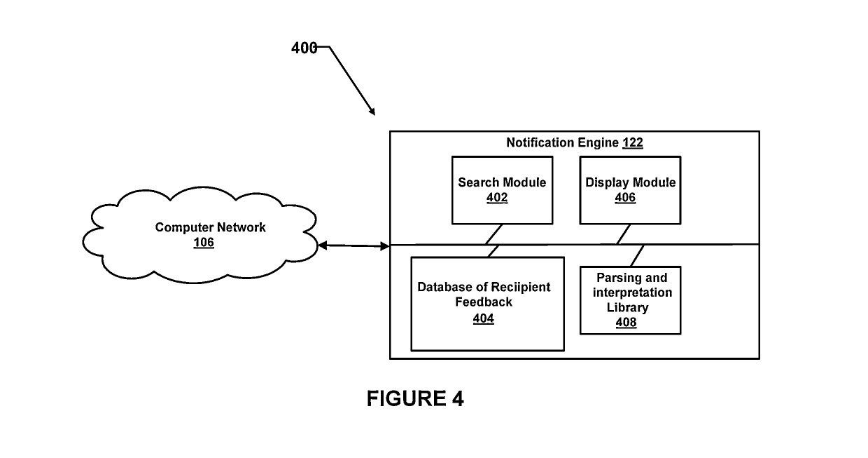

FIG. 4 is a block diagram of a Notification Engine

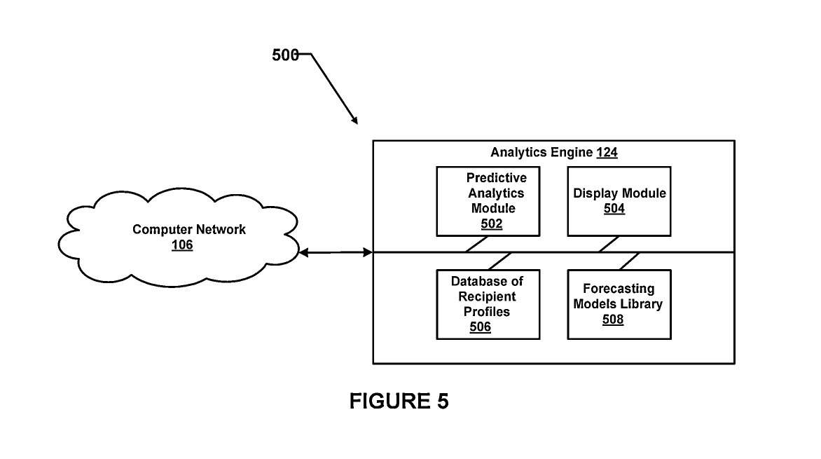

FIG. 5 is a block diagram of an Analytics Engine.

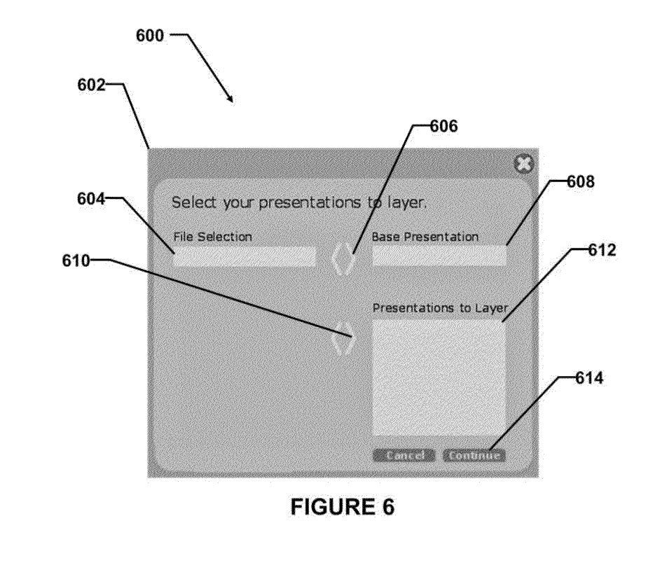

FIG. 6 is a view of the Editing Interface for Document Selection.

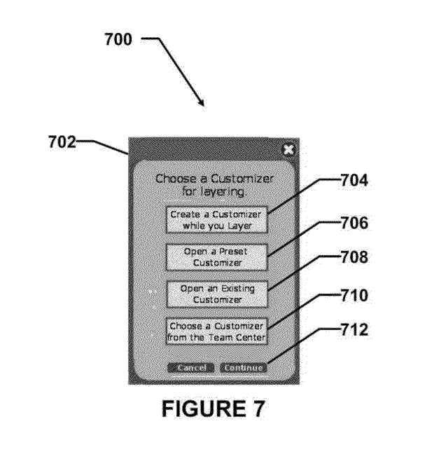

FIG. 7 is a view of the Editing Interface for Merge Method Selection.

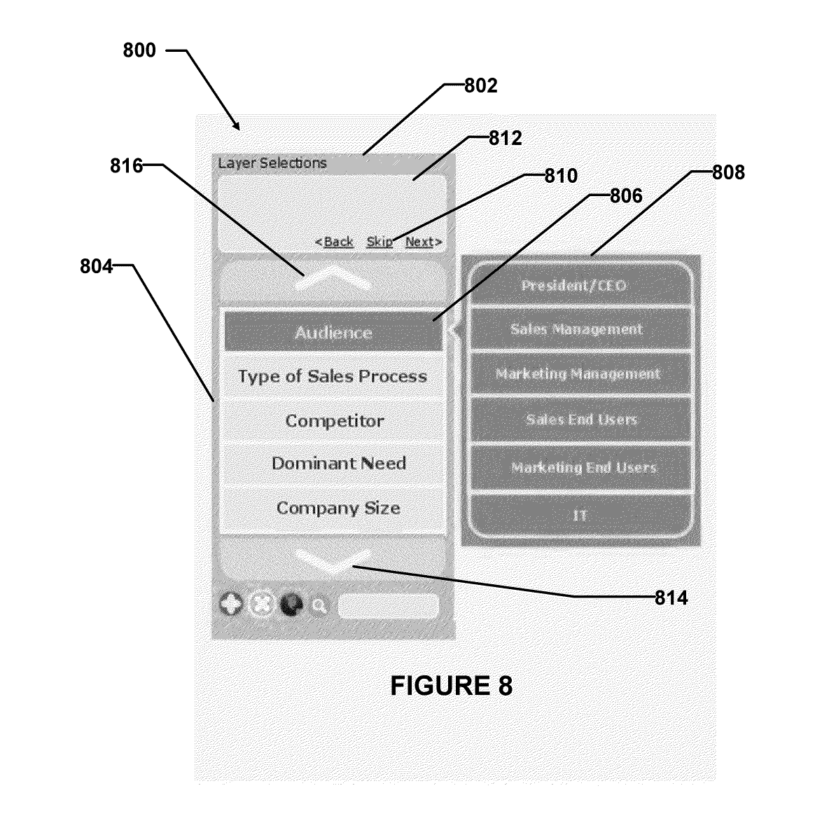

FIG. 8 is a view of the Editing Interface for Selection of Customizer Layers for Merging by means of choosing variation reason.

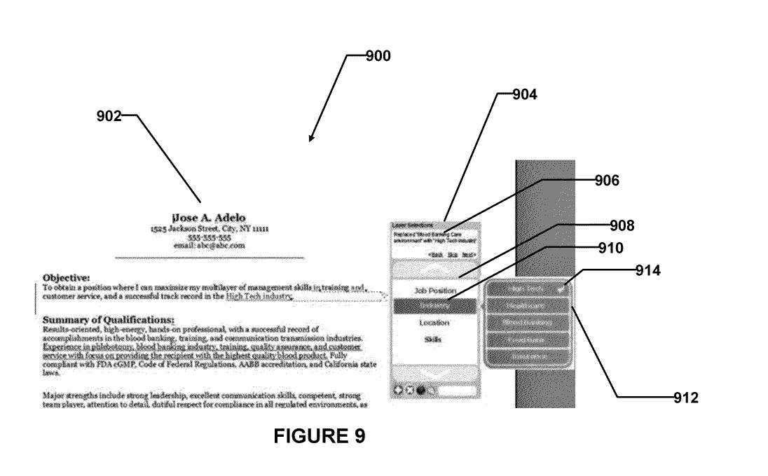

FIG. 9 is a view of the Editing Interface for Selection of Customized Layers for Merging in the case of customizing a resume.

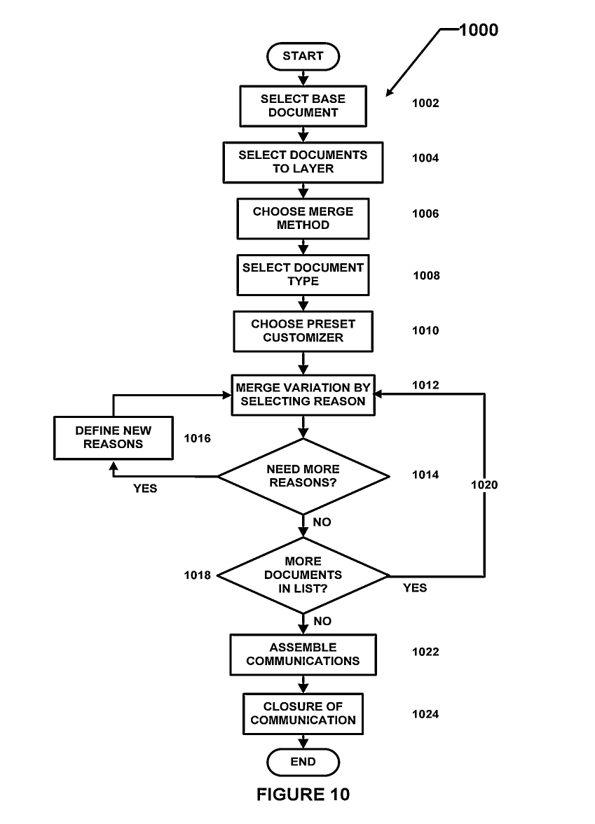

FIG. 10 is a flowchart for generating communications from a Preset Customizer.

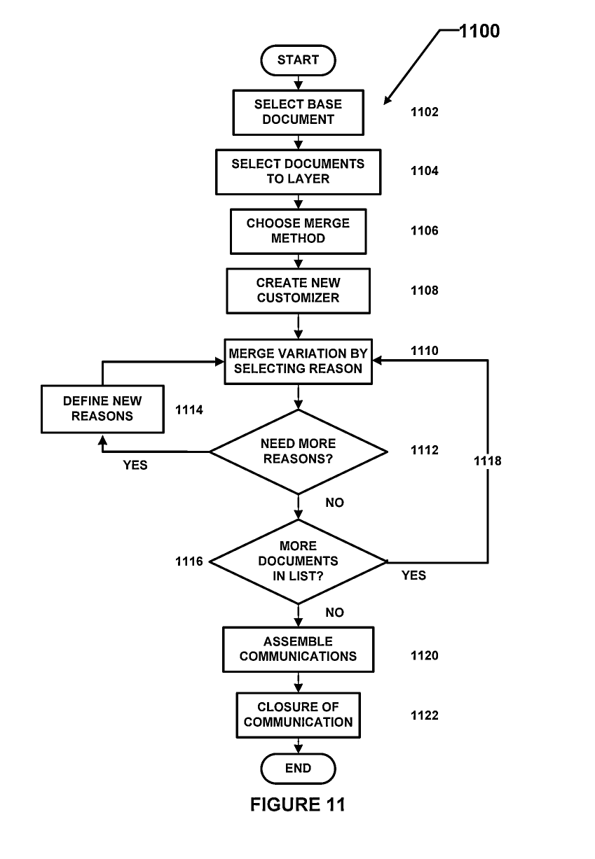

FIG. 11 is flowchart for generating communications from a Constructed Customizer

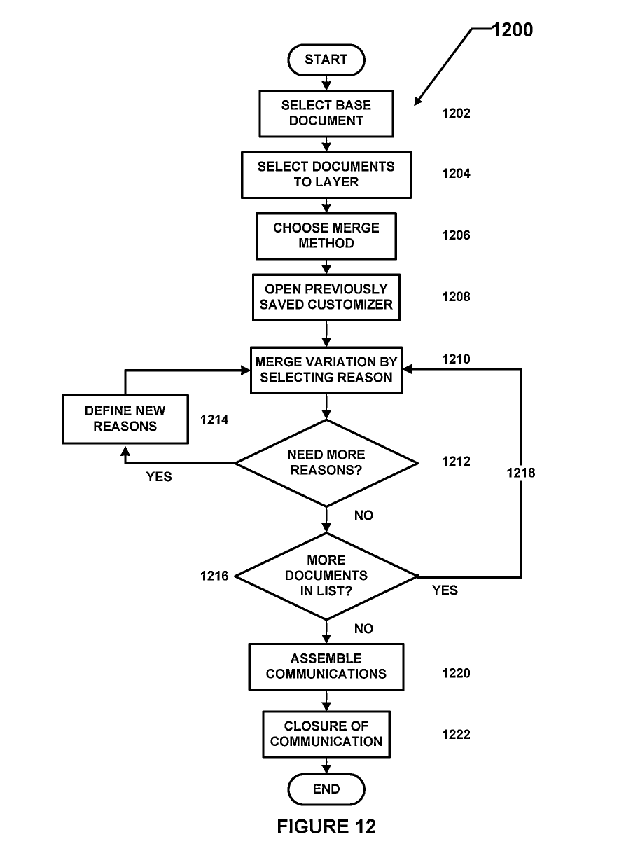

FIG. 12 is a flowchart for generating communications from a Saved Customizer.

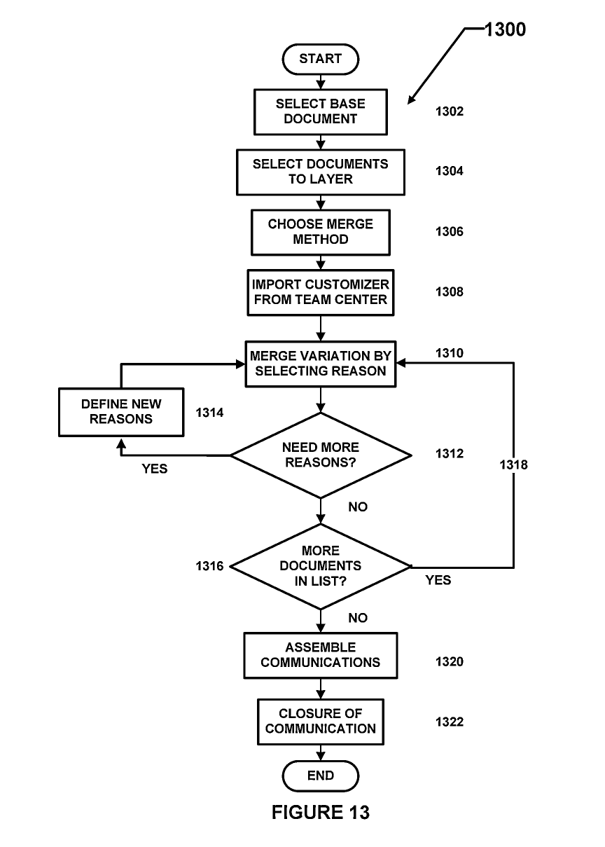

FIG. 13 is a flowchart for generating communications from an Imported Customizer.

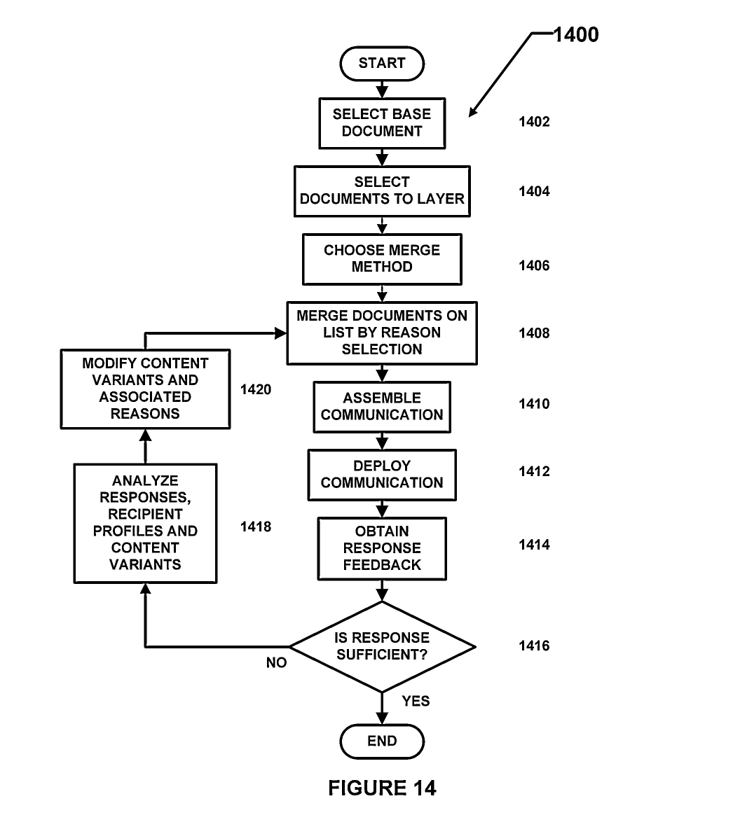

FIG. 14 is a flowchart for modifying a Customizer based on recipient feedback

The invention is described above with reference to block and flow diagrams of systems, methods, apparatuses, and/or computer program products according to exemplary embodiments of the invention. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the invention.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a non-transitory computer-readable memory that can direct a computer or other programmable data processing apparatus to function in a particular manner, such that the instructions stored in the non-transitory computer-readable memory produce an article of manufacture including instruction means that implement one or more functions specified in the flow diagram block or blocks. As an example, embodiments of the invention may provide for a computer program product, comprising a non-transitory computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks. In one embodiment, said computer program instructions could be delivered in a plug-in to a content editing application such as Microsoft Word so that a person from a toolbar in a graphical interface could assemble a communication from content stored as Word documents. In one embodiment, said computer program instructions could be delivered on a standalone computer such as a laptop or a desktop. Alternately these computer-implemented processes could be virtualized in a cloud-based environment such as the Amazon Elastic Compute Cloud or Microsoft Azure Cloud.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special purpose hardware and computer instructions.

While the invention has been described in connection with what is presently considered to be the most practical and various embodiments, it is to be understood that the invention is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. To the contrary, a variety of optional components are described to illustrate the wide variety of possible embodiments of the invention.

Further, although process steps, method steps, algorithms or the like may be described in a sequential order, such processes, methods and algorithms may be configured to work in alternate orders. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

When a single device or article is described, more than one device/article (whether or not they cooperate) may be used in place of a single device/article. Similarly, where more than one device or article is described (whether or not they cooperate), a single device/article may be used in place of the more than one device or article.

Techniques and mechanisms described or reference herein will sometimes be described in singular form for clarity. However, particular embodiments include multiple iterations of a technique or multiple instantiations of a mechanism unless noted otherwise.

The system described here enables a principal user or team of users on a network to generate complex communications, which may include a resume, a fund-raising appeal, an advertisement, a marketing communication, a travel brochure, a multimedia presentation, or a website. The principal user or team of users may generate said communications employing the present invention without technical knowledge of the content tool, which may include word processor, presentation tool, or website development tool, provided that the principal user or members of the team of users are familiar with and can simply follow step-by-step directions.

FIG. 1 is an exemplary configuration of a system, 100, for an embodiment of the present invention. The Principal User, 102, by means of his computing device, 104, which is connected to the Computer Network, 106, is enabled to generate a communication customized to a particular set of recipients, 112, or a particular recipient, 112B. The Computer Network, 106, further connects to the Content Layering Engine, 118, the Communication Engine, 120, the Notification Engine, 122, and the Analytic Engine, 124. These engines and services are connected to Computer Network Storage, 108, drawn upon a database server, 114, for network-accessible databases, 116A, 116B . . . 116N, which include the content data, recipient characteristics and locations as well as historical data such as feedback from previous communications. The communications generated by the Principal User, 102, or Team of Users, 126, are targeted at network-enabled Recipients, 112 (112A, 112B . . . 112M).

The Principal User, 102, would include Graphic Designers, Copywriters, Salespersons, and Administrative Assistants or others required to generate complex differential communications targeted at individual recipients.

The computer network could be an intranet on a standalone computer, or local server internet used within a corporate information technology environment, or a distributed server internet used within multiple locations of a corporation, or the internet of the World Wide Web securely accessed by authenticated users, or any other computer network system.

It will be apparent, however, to one skilled in the art, that the framework described may be practiced using only voice communication or text communication and or more broadly for expertise in various domains. For example, a business may wish to deploy a video commercial to several remote locations simultaneously and receive feedback from text messages sent by telephone.

It will be apparent, however, to one skilled in the art, that the framework described may be practiced for more than communicating multimedia messages at future times. For example, a business in the event of an emergency such as a network outage may wish to deploy an alert message to several remote locations simultaneously by fax system with instructions customized to each particular remote location.

FIG. 2 is a block diagram, 200, of a Content Layering Engine, 118, of the system, 100. The Content Layering Engine, 118, facilitates for the Principal User, 102, the generation of communications to multiple different sets of recipient within a single master communication document by means of a graphical user interface on a display module, 204, for an Expert Layer Wizard, 202. The Expert Layer Wizard, 202, enables the Principal User, 102, to select a generic base document from a library of documents in a folder or database of existing content for individualized display and future editing. The Expert Layer Wizard, 202, guides the Principal User, 102, through a series of steps that highlight specific edits, defining categories of reasons from a library of categories, 208, for the application of each segment, generating an unlimited number of layered edits to the base document and merge several files into a single file for review or further editing When the Principal User, 102, is presented with a document variation that does not require the creation of a separate reason, the Principal User, 102, selects and tags that variation to one of the reasons already entered. In some embodiments a Team of Users, 126, may work together to generate a layered document customizer. For instance, copywriters developing advertizing or marketing communications or scriptwriters collaborating on a movie or television script.

In some cases the Customizer, 206, is constructed ab initio with the Expert Layer Wizard, 202, and then the Principal User, 102, merges content with the Customizer, 206, to generate a communication. In some cases the Expert Layer Wizard, 202, guides the Principal User, 102, through a specified set of documents and a selected preset Customizer, 206, to create the merged communication using preset Customizer templates selected from a database. In some cases the Expert Layer Wizard, 202, guides the Principal User, 102, to create the merged communication using a Customizer, 206, previously saved by the Principal User, 102. In some cases, the Expert Layer Wizard, 202, guides the Principal User, 102, to import a previously constructed Customizer, 206, from the Team Center, 126, a set of Users, 126A . . . 126N, using a web-based application, Team Center, 126. The Customizer, 206, is interactive so that after the documents have been merged into a communication, the Principal User, 102, can review the layering of the document by toggling subcategories to view how the document appears with different variations selected; moreover, the Principal User, 102, will be able to group subcategories defined during the merge process into Category groupings. The final merged communication can be saved in the format of the content tool from which the content was derived.

FIG. 3 is a block diagram, 300, of a Communication Engine, 120, of the system, 100. The Communication Engine, 120, facilitates assembly and deployment of targeted communications by the Principal User, 102. The Communication Engine, 120, provides the Principal User, 102, with information about a recipient's best contact information, profile interest information and/or affinity information in a Recipient Database, 308. In some examples, said information is shown to the Principal User, 102, by the Display Module, 304. The Recipient Database, 308, may receive data relevant to the location of a recipient from a GPS translation module, 306. For example, if the targeted recipient is traveling or in a particular location the communication generated by the Principal User, 102, can be modified accordingly.

FIG. 4 is a block diagram, 400, of a Notification Engine, 122, of the system, 100. The Notification Engine, 122, facilitates effective communications by providing feedback to the Principal User, 102, on the response of the targeted recipients of a communication or on delivery of a targeted communication to an intended recipient, as provided by the Database of Recipient Feedback, 404, as interpreted by the aid of a Parsing and Interpretation Library, 408. For example, if the Principal User, 102, is notified that the open rate of particular communication exceeds that of another communication that differs in content for some categories then the Principal User, 102, can use the response propensity to improve future communications to that recipient or class of recipients.

FIG. 5 is a block diagram of the Analytics Engine, 124, of the system, 100. The Analytics Engine, 124, facilitates transforming the feedback information generated by the Notifications Engine, 122, to enable the Principal User, 102, to improve propensity to respond by the recipients, 112, by generating a more effective communication.

A predictive analytics module, 502, in Analytics Engine, 124, applies algorithms and forecasting models stored in a forecasting models library, 508, to analyze present and/or historical recipient user data in view of recipient data profiles database, 506, to identify essential categories and to suggest appropriate media messages or items for a recipient user, 112. In some embodiments the predictive analytics module, 502, implements a variety of forecasting techniques beyond simple algorithms, such as future date calculation, including statistical techniques such as machine learning (e.g., as applied by IBM's Watson computer), game theory, and data mining, to analyze current and historical data to determine propensities from notification information, to make predictions about future recipient responses, to identify effective communication messages, and to identify appropriate delivery times and methods, among a wide variety of other analyses and algorithms. By a computer-implemented method, data relevant to the recipient user may be extracted from his profile in the system 100 and/or generated implicitly based, at least in part, on the recipient user's stored profile together with historical data by a predictive analytics algorithm based on historical data.

In some cases, the predictive analytics module, 502, may also incorporate present or historical data or both to identify relevant information for the communication message or recipient user or both that are in keeping with preferences of the Principal User, 102.

A display module, 504, of the Analytics Engine, 124, may display for example the response rate of recipients, 112, to a plurality of variations of communication in a window or webpage accessible to the Principal User, 102. The changes in the subcategory selection that maximize propensity to response may be sent to the Customizer, 202, of the Communication Engine, 122, for deployment of new communications.

In some embodiments, the predictive analytics implemented by the Analytics Engine, 124, incorporate the robust, optimizing forecasting techniques of Pinto et al. (U.S. Pat. No. 7,499,897, issued on Mar. 3, 2009; U.S. Pat. No. 7,562,058, issued on Jul. 14, 2009; U.S. Pat. No. 7,725,300, issued on May 25, 2010; U.S. Pat. No. 7,730,003, issued on Jun. 1, 2010; U.S. Pat. No. 7,933,762, issued on Apr. 26, 2011; U.S. Pat. No. 8,165,853. issued Apr. 24, 2012; U.S. Pat. No. 8,170,841, issued May 1, 2012; U.S. Pat. No. 8,751,273, issued on Jun. 10, 2014; and U.S. patent application Ser. No. 10/826,949, filed Apr. 16, 2004, the contents of all of which are incorporated herein by reference), that manage historical data using missing values, which must be inferred.

FIG. 6 shows an exemplary embodiment of the Editing Interface for Document Selection, 600, presented to the Principal User, 102. In the drop down list of the File Menu of the content creation tool, the Principal User, 102, selects Begin Document Layering that opens the Dialog Box, 602. From the Dialog Box, the Principal User, 102, browses for and clicks on the Base Document whose file path displays in the File Selection area, 604. The Principal User, 102, clicks on the right arrow, 606, to move the file name to the Base Document area, 608. The Principal User, 102, browses for and clicks on the Document to Merge file whose file path displays in the file selection area, 604. Then the Principal User, 102, clicks on the right arrow, 610, to move the file name to the Presentations to Layer area, 612, of the Dialog Box. The Principal User, 102, can continue to add files to list of files to be Merge and reorder the files by selecting the file name and the appropriate arrow. When the choice has been made the Principal User, 102, clicks on the Continue Button, 614.

FIG. 7 shows an exemplary embodiment of the Editing Interface for Customizer Generation, 700, presented to the Principal User, 102. In the Customizer Generation Dialog Box, 702, the Principal User, 102, clicks on one of four buttons to select the mode of generation for the Customizer, 202, to be produced by the Content Layer Engine, 118, the Create a Customizer while you layer Button, 704, that provides for customized document creation as shown in FIG. 11; the Open a Preset Customizer Button, 706, that provides for customized document creation as shown in FIG. 10; the Open an Existing Customizer Button, 708, that provides for customized document creation as shown in FIG. 12; the Choose a Customizer from the Team Center Button, 710, that provides for customized document creation as shown in FIG. 13. When the list is choice has been made the Principal User, 102, clicks on the Continue Button, 712.

FIG. 8 shows an exemplary embodiment of the Editing Interface for Selection of Customizer Layers for Merging by means of choosing content variation reasons, 800, presented to the Principal User, 102. The Layer Selection Dialog Box, 802, displays a list of content variation classifiers or reasons, 804. Depending on the classifier selected there are different options or reasons, 804. For example, the label Audience, 806, may have content varied according to a list of subcategories, 808, such as whether the audience of a customized software sales communication is directed at the President/CEO, Sales Management, Marketing Management, Sales End Users, Marketing End Users, IT. Depending on the classifier or reason selected different options will be displayed. When an option is selected the content variant will display in the Layer Selection area, 812, for review by the Principal User, 102, who can toggle with the controls, 810, using the controls <Back Skip Next> between content variants to select the appropriate version. By selecting a classifier label then clicking on the Up Arrow, 816, or the Down Arrow, 814, the Principal User, 102, can reorder the list.

FIG. 9 shows an exemplary embodiment of the Editing Interface for Selection of Customizer Layers for Merging by means of choosing content variation reasons, 900, presented to the Principal User, 102, for customizing a resume, 902, presented on a computer display. In the Content Layering Dialog Box, 904, the Principal User, 102, is presented with a variation between the two documents and has the opportunity to select a reason for that difference. In this case, the phrase, Blood Banking Industry, would be substituted by another phrase, High Tech Industry, as shown, 906, and is reflected in the document, 902. The Principal User, 102, makes the choice from a list of categories, 908, specifically the category, Industry, 910, and within that category a list of reasons, 912, of which the one for High Technology, 914, is selected.

FIG. 10 is a flowchart of an example process, 1000, for the generation of a communication using the Communication Layering Engine, 118, by the Principal User, 102, from a Customizer, 202, that has been preset as a template. The Principal User, 102, then selects a base document,

Step 1002, then selects the documents to be layer together into a composite, Step 1004. The Principle User, 102, then selects the Merge Method to be used, Step 1006, which, in this case, is the Preset Customizer option. Then the Principal User, 102, selects a document type, Step 1008, to filter for the set of available preset Customizers for that type of document. From the group of preset Customizers templates then Principal User, 102, designates the preset Customizer template to be applied, Step 1010. The Principal User, 102, begins the merger by selecting reasons, Step 1012, and then determining if further reasons to merge contents variants are required, Step 1014. If so, the Principal User, 102, may create additional reasons, Step 1016. If not, the Principal User, 102, checks to see if there are additional variant edits on the list to be merged, Step 1018. If so, the Principal User 102 continues to merge, Step 1020, by selecting a reason associated with the next document to extract and merge the content variation, Step 1012. If not, the Principal User 102 assembles and reviews the customized communication; Step 1022, and then completes the communication ready for saving or deployment, Step 1024.

FIG. 11 is a flowchart of an example process, 1100, for the generation of a communication using the Communication Layering Engine, 118, by the Principal User, 102, from a Customizer, 202, that is generated in the layering process. The Principal User, 102, then selects a base document, Step 1102, then selects the documents to be layer together into a composite communication, Step 1104. Then the Principal User, 102, selects a Merge Method to be used, Step 1106, which in this case is creating a New Customizer, Step 1108. The Principal User 102 then chooses a reason as the grounds for merging a particular content variation, Step 1110, then determining if further reasons to merge content variants are required, Step 1112. If so, the Principal User may create additional reasons, Step 1114. If not, the Principal user checks to see if there are additional documents on the list to be merged, Step 1116. If so, the Principal User, 102, continues to merge, Step 1118, by selecting a reason associated with the next content variant to extract and merge the content variation, Step 1110. If not, the Principal User 102 assembles and reviews the customized communication; Step 1120, and then completes the communication ready for saving or deployment, Step 1122.

FIG. 12 is a flowchart of an example process, 1200, for the generation of a communication using the Communication Layering Engine, 118, by the Principal User, 102, from a Customizer, 202, that had been previously saved. The Principal User, 102, then selects a base document, Step 1202, then selects the documents to be layer together into a composite, Step 1204. Then the Principal User, 102, selects a document type, Step 1206, to filter for the set of available preset Customizer templates. From the group of preset Customizers templates then Principal User, 102, designates the preset Customizer template to be applied, Step 1208. The Principal User, 102, then selects the Merge Method and the Merge method to be used, Step 1210. At that juncture the content insert reason associated with that variation is displayed, Step 1212. Now the Principal User must decide if that reason is accepted, Step 1214. If not, the Principal User, 102, checks to see if there are additional content variants on the list to be merged, Step 1216. If so, the Principal User, 102, continues to merge, Step 1218, by selecting a reason associated with the next document to extract and merge the content variation, Step 1210. If not, the Principal User, 102, assembles and reviews the customized communication, Step 1220, and then completes the communication ready for saving or deployment, Step 1222.

FIG. 13 is a flowchart of an example process, 1300, for the generation of a communication using the Communication Layering Engine, 118, by the Principal User, 102, from a Customizer, 202, that had been imported from the Team Center, 126. The Principal User, 102, first selects a base document, Step 1302, then the Principal User, 102, selects the documents to be layered together into a composite, Step, 1304. Next the Principal User, 102, selects a Merger Method, Step 1306, which in this case is by using an existing Customizer previously saved, Step 1308. The Principal User, 102, begins the merger by selecting reasons, Step 1310, then determining if further reasons to merge content variants are required, Step 1312. If so, the Principal User, 102, may create additional reasons, Step 1314. If not, the Principal User, 102, checks to see if there are additional content variants on the list to be merged, Step 1316. If so, the Principal User, 102, continues to merge, Step 1318, by selecting a reason associated with the next document to extract and merge the content variation, Step 1310. If not, the Principal User, 102, assembles and reviews the customized communication, Step 1320, and then completes the communication ready for saving or deployment, Step 1322.

FIG. 14 is a flowchart of an example process, 1400, for modifying a Customizer, 202, in Content Layering Engine, 118, based on feedback from the recipients, 114, as received and processing by the Notification Engine, 122, following deployment of one or more communications by the Communication Engine, 120, and enhanced for maximal propensity of response by the Analytics Engine, 124. The Principal User, 102, then selects a base document, Step 1402, then selects the documents to be layered together into a composite, Step 1404. Next the Principal User, 102, selects a Merger Method, Step 1406, and proceeds to create a customized communication by selecting reasons for content variations to be included in the communication, Step 1408, and subsequently assembles and reviews the customized communication, Step 1410, as previously described in FIG. 10 thru FIG. 13. Then, using the Communication Engine, 120, the Principal User, 102, sends the customized communication to the targeted set of recipients or a representative sample subset, Step 1412. Next using the Notification Engine, 122, the feedback response is obtain from the recipients, Step 1414, and evaluated, Step 1416. If the response meets a predetermined criterion then the Customizer has been adequately modified to produce an appropriate customized communication. If not, then the present data as well as historical data are analyzed using the Analytic Engine 124, Step 1418, to more appropriately adjust the content variants, Step 1420, to increase the targeted response.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

Other implementations are also within the scope of the following claims.

We claim:

1. A communication system comprising:
(a) A content layering engine;
(b) A communications engine;
(c) A notification engine;
(d) An analytics engine;
wherein a user selects communication messages based on targeted markets.

2. The communication system of claim 1, further comprising a computer network in connection with a storage location.

3. The communication system of claim 1, further comprising a content layering engine for layering a plurality of communication messages into a single file.

4. The communication system of claim 1, further comprising a categories library for each subset of recipients.

5. The communication system of claim 1, further comprising a display module to visualize the user experience of recipients of communication messages.

6. The communication system of claim 1, further comprising a communications engine wherein an assembly module and a display module and a recipient database are in communication as needed.

7. The communication system of claim 1, further comprising a parsing and interpretation library for comparing communication messages.

8. The communication system of claim 1, further comprising a predictive analytics module for filling in missing data.

9. The communication system of claim 1, further comprising a forecasting models library from which to select a model to forecast response to a communication message.

10. The communication system of claim 1, further comprising a base presentation on which to layer additional modifications.

11. A computer-based method for layering communication messages, the computer-based method comprising:
(a) layering content securely from a plurality of sources;
(b) communicating among a content layering engine, a communications engine, a notification engine, and an analytics engine;
(c) notifying the user of communication messaging success
(d) selecting from alternates using predictive analytics based on historical data.

12. The computer-based method of claim 11, further comprising connecting with a storage location.

13. The computer-based method of claim 11, further comprising creating a customizer for the creation of a communication message.

14. The computer-based method of claim 11, further comprising opening a preset customizer for creating a communications message.

15. The computer-based method of claim 11, further comprising opening an existing customizer for creating a communications message.

16. The computer-based method of claim 11, further comprising creating a customizer based on analysis of historical data.

17. A computer-based method for selecting layers based on selected criteria, further comprising selecting criteria from a list or adding criteria to a list, the computer-based method comprising:
a) Selecting an audience for the communication message;
b) Selecting the type of sales process appropriate to the selected audience;
c) Selecting the type of competitor in the market
d) Selecting the primary purpose of the communication message
e) Selecting the size of the target company

18. The computer-based method of claim 17, further comprising creating customizers based on predictive analytics and historic data.

19. The computer-based method of claim 17, further comprising layering content into a single file for easy storage and retrieval.

20. The computer-based method of claim 17, further comprising storing the customized layers in an on-line storage device.
